(19) United States
(12) Patent Application Publication
(10) Pub. No.: US 2026/0270698 A1
(43) Pub. Date: Sep. 10, 2026

(54) System and method for mitigating mobile device security threats

(71) Applicant: Bank of America Corporation, Charlotte, NC (US)

(72) Inventors: Abhijit Behera, Hyderabad (IN); Maneesh Kumar Sethia, Hyderabad (IN); Sivashalini Sivajothi, Chennai (IN)

(21) Appl. No.: 19/074,995

(22) Filed: Mar. 10, 2025

(51) Int. Cl. H04W 12/06; H04W 4/12; H04W 8/20; H04W 12/61

(52) U.S. Cl. CPC H04W 12/06; H04W 4/12; H04W 8/20; H04W 12/61

(57) ABSTRACT

A system for receiving an authentication request to authenticate a wireless interaction initiated at the user device. The authentication request comprises one or more eSIM (embedded Subscriber Identity Module) status indicators associated with an eSIM of the user device, and one or more eSIM status indicators comprises a newly activated eSIM indicator. Further, the system compares a timestamp with a threshold time period to determine if the timestamp exceeds the threshold time period and creates the first messaging request based on one or more messaging parameters. The system further initiates the encrypted alternate messaging platform on the user device, and the encrypted alternate messaging platform is configured to display the first messaging request.

### TECHNICAL FIELD

The present disclosure relates generally to network and device monitoring and, more specifically, to a system and method for mitigating mobile device security threats.

### BACKGROUND

A SIM card or SIM (Subscriber Identity Module) may be an integrated circuit (e.g., a physical “SIM card”) that is intended to securely store an international mobile subscriber identity (IMSI) number and its related key, used to identify and authenticate users on mobile devices. In some examples, a SIM can be an embedded SIM (eSIM), which is a programmable SIM (i.e., a digital version of the physical SIM card) that is embedded directly into the mobile device. An eSIM is a digital SIM that facilitates a connection to a mobile network without a physical SIM card. eSIMs are vulnerable to fraudulent attacks by bad actors. A type of eSIM-related fraudulent attack involves a potential cloning of an eSIM profile for malicious purposes as part of installing a new eSIM on a mobile device, which compromises network security as well as data security for the mobile device user. For example, bad actors (i.e., malicious user devices) can impersonate a mobile device user to perform eSIM cloning. This can result in undesirable disclosure of information, detrimental utilization of user accounts, and/or unauthorized transfers of funds.

### SUMMARY

The disclosed system, described in the present disclosure, is particularly integrated into a practical application of mitigating mobile device security threats. The disclosed system addresses technical problems rooted in mobile device wireless communications and achieves technical improvements to the network and the user devices used in wireless communications, as well as underlying computer systems that facilitate wireless communications.

The system and method implemented by the system, as disclosed in the present disclosure, provide technical solutions to the technical problems discussed above by generating an end-to-end encrypted alternate messaging platform.

Conventional technologies are not configured to provide a reliable and efficient solution to overcome such eSIM-related fraudulent attacks. To overcome such eSIM-related fraudulent attacks, conventional technologies require cellular network carriers to temporarily block cellular SMS (short message service) services on a mobile device when a new eSIM is installed on the mobile device. Conventional technologies suffer from several drawbacks. For example, because SMS services are blocked on a mobile device, users are not able to receive SMS messages containing one-time password (OTP) codes that are required as part of authentication for certain operations (e.g., transfer of funds). Further, when cellular SMS services are not available or blocked, mobile device users may rely on third-party applications to perform communications over Wi-Fi. Such third-party-based applications may not be secured (e.g., weaker security measures such as unencrypted communications) and thus may lead to compromising network security and data security. The compromised network security (e.g., unauthorized access of a network) and data security (e.g., sensitive information associated with a user of the mobile device). This information that is stolen by bad actors (e.g., hackers) can lead to security breaches, identity theft, and unauthorized access to confidential and sensitive information held by an underlying entity associated with the user. Bad actors may even incorrectly route calls and data sessions.

Another example is mass eSIM-related fraudulent attacks (i.e., in large numbers) that can overload the authentication and provisioning of servers, causing service degradation and/or network outages for a cellular carrier. Such mass eSIM-related fraudulent attacks can lead to network resource depletion (because of increased network load), which increases network latency associated with performing, for example, operations (e.g., cellular data-related operations) by legitimate user devices. These operations may include, for example, voice calls, video calls, and data transmission (files, pictures, videos, etc.) by legitimate user devices. This increase in network latency associated with operations results in the slower processing of network operations, resulting in network traffic bottlenecks.

Network traffic bottlenecks may result in the queuing of operations in an operations queue, which can have several negative effects on overall network performance. For example, when each operation in an operations queue takes longer to complete due to high latency, the total time required to process all the operations within the operations queue increases. This directly affects the network's ability to process and transfer data efficiently, leading to slower overall system performance. Higher latency reduces throughput, which is the amount of data transmitted across the network in a given time period. This occurs because each operation takes longer to complete, resulting in fewer tasks being processed in the same amount of time. Higher latency associated with performing the operations also results in inefficient use of computing resources in the network. For example, high latency can lead to inefficient use of network resources. For instance, when high latency delays the execution time of operations, systems may remain idle while waiting for responses, leading to poor utilization of resources like CPU, memory, and bandwidth. In addition, when operations with high latency stack up or accumulate due to delays, they can create queues at intermediate network devices like routers, switches, and firewalls. This results in congestion of the network devices, thus lowering the performance of these devices. Also, when latency increases, applications and servers may be forced to wait longer for responses from external systems or databases. This added delay can lead to increased load on the system, as operations back up while waiting for network responses, reducing the efficiency and performance of a cellular network.

Embodiments of the present disclosure provide several practical applications and technical advantages that provide solutions to the problems discussed above in relation to conventional computing systems and networks. For example, the disclosed system and methods provide the practical application of generating an end-to-end encrypted alternate messaging platform.

In some embodiments, a system for generating an end-to-end encrypted alternate messaging platform includes a processor operably coupled to the memory and the memory configured to store a plurality of smart contracts. A first smart contract of the plurality of smart contracts includes one or more messaging parameters utilized to configure a first messaging request displayed at an encrypted alternate messaging platform of a user device. The processor is configured to receive an authentication request to authenticate a wireless interaction initiated at the user device. The authentication request comprises one or more eSIM (embedded Subscriber Identity Module) status indicators associated with an eSIM of the user device and the one or more eSIM status indicators comprises a newly activated eSIM indicator. The processor is configured to determine if the one or more eSIM status indicators comprises the newly activated eSIM indicator, wherein the newly activated eSIM indicator provides a timestamp indicating when the eSIM was activated in conjunction with the user device.

The processor further compares the timestamp with a threshold time period to determine if the timestamp exceeds the threshold time period in response to determining that the one or more eSIM status indicators comprises the newly activated eSIM indicator. The processor further selects the first smart contract of the plurality of smart contracts in response to determining that the timestamp does not exceed the threshold time period. The first smart contract includes the one or more messaging parameters utilized to configure the first messaging request. The processor further creates the first messaging request based on the one or more messaging parameters and in conjunction with creating the first messaging request, initiates the encrypted alternate messaging platform on the user device. The encrypted alternate messaging platform is configured to display the first messaging request and transmit the first messaging request to the user device. The first messaging request includes a first authentication data utilized to authenticate the authentication request. The processor further receives second authentication data from the user device in response to transmitting the first messaging request and compares the received second authentication data with the first authentication data to determine if the second authentication data matches the first authentication data. The processor further authenticates the authentication request of the user device based on determining that the second authentication data matches with the first authentication data and completes the wireless interaction initiated at the user device in response to authenticating the authentication request.

By generating an end-to-end encrypted alternate messaging platform, the disclosed system and method reduces or prevents sensitive information from being stolen by bad actors (e.g., hackers) that can lead to security breaches, identity theft, and unauthorized access to confidential and sensitive information held by an underlying entity associated with the user. Further, by controlling confidential and sensitive information, bad actors (e.g., hackers) cannot use them to unlock accounts or bypass security measures (e.g., multi-factor authentication security).

Additionally, mass eSIM-related fraudulent attacks are evaded thus reducing or avoiding delays associated with cellular data-related operations and thus reducing overall latency in the computing network. Lowering latency associated with performing cellular data-related operations in a computing network can improve network performance and computing performance in several ways and result in several technical advantages. For example, lower latency means cellular data-related operations are completed more quickly. This results in faster processing and data exchange across the network. Lower latency increases throughput of the network and user devices connected to the network. Since each operation in a sequence takes less time to complete, more operations can be processed in the same amount of time, resulting in higher throughput. With reduced latency, network and server resources are used more efficiently. Servers spend less time waiting for responses from other systems and can focus on processing operations more rapidly, leading to better resource utilization. Lower latency also reduces the time spent waiting in queues for resources or data. This minimizes the chance of congestion or backlogs at network devices (e.g., routers, switches) or servers. As a result, data flows more freely through the network. In addition, reducing latency helps optimize bandwidth by allowing data to flow more efficiently. When cellular data-related operations are completed more quickly, less bandwidth is wasted on waiting for data to be acknowledged or retransmitted, and the network can handle higher volumes of traffic.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings, in which:

FIG. 1 is a schematic diagram of a system, in accordance with an embodiment of the present disclosure;

FIG. 2 illustrates a rules database and smart contracts database, in accordance with one or more embodiments of the present disclosure; and

FIG. 3 illustrates an example flowchart of a method of the system of FIG. 1, for generating an end-to-end encrypted alternate messaging platform.

### DETAILED DESCRIPTION

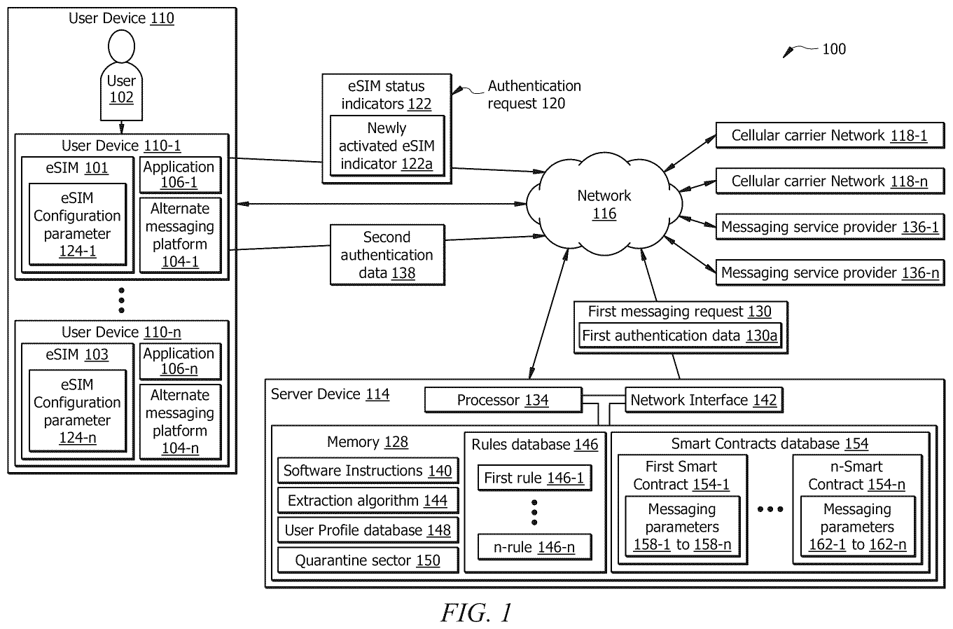

As described above, conventional technologies fail to overcome eSIM-related fraudulent attacks. Embodiments of the present disclosure and its advantages may be understood by referring to FIGS. 1-3. FIGS. 1-3, which are used to describe systems and methods for generating an end-to-end encrypted alternate messaging platform to mitigate eSIM-related fraudulent attacks, according to some embodiments.

### System Overview

FIG. 1 is a schematic diagram of a system 100, in accordance with certain embodiments of the present disclosure. As shown, system 100 includes a plurality of user devices 110-1 to 110-n, a server device 114, a plurality of cellular carrier networks 118-1 to 118-n, and a plurality of messaging service providers 136-1 to 136-n operably connected to one another via a network 116. Network 116 enables communication among the components of the system 100. The plurality of user devices 110-1 to 110-n are collectively or individually referred to as user device 110. In general, system 100 generates an end-to-end encrypted alternate messaging platform to mitigate eSIM-related fraudulent attacks.

### System Components

### User Device

System 100 includes user devices 110-1 to 110-n, these are collectively referred to as user device 110. The user devices 110-1 to 110-n may generally be any device configured to process data. User devices 110-1 to 110-n may also include but are not limited to, a personal computer, a desktop computer, a workstation, a server, a laptop, a tablet computer, a mobile phone (such as a smartphone), an Internet-of-Things (IoT) device, a wearable computing device, smart glasses, smart watches or bracelets, phablets, other smart devices, devices configured for wired or wireless RF (Radio Frequency) communication, or any other suitable type of device. The user devices 110-1 to 110-n may include a user interface, such as a display, a microphone, a camera, a keypad, or other appropriate equipment usable by a user. User devices 110-1 to 110-n are utilized to perform wireless interaction by utilizing one or more applications 106-1 to 106-n. The applications 106-1 to 106-n may be any web application utilized to perform a wireless interaction with server device 114. For example, user device 110-1 performs a wireless interaction with application 106-1 to access user profile information associated with user 102 stored at user profile database 148 of the server device 114. User profile information may include user account information, although any other information that user device 110-1 can access may also be included in the user profile database 148. Each user device 110 includes an eSIM (embedded Subscriber Identity Module) (e.g., eSIM 101, eSIM 103).

### eSIM Configuration Parameters

In an embodiment, the eSIM 101 of the user device 110-1 is utilized by the user device 110-1 to connect with one of the cellular carrier networks 118-1 to 118-n to perform cellular operations, such as make phone calls, video calls, messaging service, cellular data services, etc. The eSIM 101 includes eSIM configuration parameters 124-1. The eSIM configuration parameters 124-1 include one or more eSIM status indicators 122. The one or more eSIM status indicators 122 provides information of the eSIM 101 to indicate if the eSIM 101 is a newly activated eSIM or if there is a change or an update to at least one of the plurality of eSIM network parameters.

The eSIM configuration parameters 124-1 may also include a phone number associated with the eSIM 101, and a plurality of eSIM network parameters. The plurality of eSIM network parameters includes a carrier URL (Uniform Resource Locator) (i.e., a first eSIM network parameter), SM-DP+ server address (Subscription Manager Data Preparation Address) (i.e., a second eSIM network parameter), a data roaming status indicator (i.e., a third eSIM network parameter), and/or a network selection indicator (i.e., a fourth eSIM network parameter).

For example, eSIM 101 of the user device 110-1 is assigned the phone number to perform cellular operations using the cellular carrier network 118-1, a carrier URL (Uniform Resource Locator) is the URL for a server associated with the eSIM 101 at the cellular carrier network 118-1, SM-DP+server address (Subscription Manager Data Preparation Address) is the address associated with a server that manages the eSIM 101 at the cellular carrier network 118-1, a data roaming status indicator when turned ON allows eSIM 101 to access other cellular carrier networks (e.g., cellular carrier network 118-n) when the cellular carrier network 118-1 is not available to perform cellular operations, a network selection indicator indicates if the eSIM 101 can automatically select a cellular carrier network or if it is selected manually.

### Network

Network 116, in general, may be a wide area network (WAN), a personal area network (PAN), a cellular network (e.g., 3G, 4G or 5G), or any other technology that allows devices to communicate electronically with other devices. In one or more embodiments, network 116 may be the Internet. Network 116 may be configured to support any suitable type of communication protocol, as would be appreciated by one of the art's ordinary skills.

### Server Device

The server device 114 includes a processor 134 in signal communication with a memory 128 and a network interface 142. Memory 128 stores software instructions 140 that when executed by processor 134, cause processor 134 to perform one or more operations of the server device 114 described herein.

### Network Interface

Network interface 142 is configured to enable wired and/or wireless communications. The network interface 142 may be configured to communicate data between the server device 114 and user devices 110-1 to 110-n and other systems, domains, or devices. For example, the network interface 142 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 134 may be configured to send and receive data using the network interface 142. The network interface 142 may be configured to use any suitable type of communication protocol.

### Memory

The memory 128 may be volatile or non-volatile and may comprise read-only memory (ROM), random-access memory (RAM), ternary content-addressable memory (TCAM), dynamic random-access memory (DRAM), and static random-access memory (SRAM). The memory 128 may include one or more of a local database, a cloud database, a network-attached storage (NAS), etc. The memory 128 comprises one or more disks, tape drives, or solid-state drives, and may be used as an over-flow data storage device, to store programs when such programs are selected for execution, and to store instructions and data that are read during program execution. The memory 128 may store any of the information described in FIGS. 1-3 along with any other data, instructions, logic, rules, or code operable to implement the function(s) described herein when executed by processor 134. For example, the memory 128 may store rules database 146, smart contracts database 154, user profile database 148, extraction algorithm 144, quarantine sector 150, and/or any other data or instructions. The software instructions 140 may include any suitable set of instructions, logic, rules, or code operable to execute the processor 134 and perform the functions described herein, such as some or all of those described in FIGS. 1-3.

### Receive Authentication Request

In an embodiment, processor 134 of server device 114 receives an authentication request 120 from the user device 110-1. The authentication request 120 is to authenticate a wireless interaction initiated at the user device 110-1. Wireless interaction initiated at the user device 110-1 may include user 102 interacting with application 106-1 to initiate a transfer of a data value from a first account to another account stored at the user profile database 148. The authentication request 120 includes one or more eSIM status indicators 122 associated with eSIM 101 of the user device 110-1.

One or more eSIM status indicators 122 may include a newly activated eSIM indicator 122a, an updated eSIM network parameter, and/or a cellular network status indicator. The newly activated eSIM indicator 122a indicates that eSIM 101 is a new eSIM that has been installed (i.e. activated) on user device 110-1. Further, this newly activated eSIM indicator 122a provides a timestamp (T1) indicating the time at which the eSIM 101 was activated. For example, the timestamp (T1) may be “Date: 2024-12-18, Time 15:45:00”.

The updated eSIM network parameter may include a change or an update to at least one of the plurality of eSIM network parameters. For example, the updated eSIM network parameter may indicate a change to the carrier URL (i.e., a first eSIM network parameter), a change to SM-DP+server address (.e., a second eSIM network parameter), a change to a data roaming status indicator (i.e., a third eSIM network parameter), and/or a change to a network selection indicator (i.e., a fourth eSIM network parameter). The cellular network status indicator indicates if one or more of the cellular carrier networks 118-1 to 118-n that eSIM 101 connects to is unavailable. For example, when user device 110-1 is not within the network coverage area of the cellular carrier networks 118-1 to 118-n, then the cellular network status indicator indicates that cellular network services of the cellular carrier networks 118-1 to 118-n are unavailable.

In an embodiment, the cellular status indicator indicates network latency associated with cellular carrier network 118-1 that user device 110-1 is configured to connect to for cellular services. Network latency is measured by the time (in milliseconds (ms)) it takes for data to travel from one point to another on a network. For example, processor 134 determines the network latency on the cellular carrier network 118-1 is 100 ms, which exceeds a threshold network latency of (e.g., 50 ms), thus processor 134 determines since cellular carrier network 118-1 has a high network latency thus cellular carrier network 118-1 is unavailable.

In an embodiment, upon receiving the authentication request 120, processor 134 of server device 114 applies an extraction algorithm 144 to the authentication request 120 to extract one or more eSIM status indicators 122. For example, authentication request 120 may be a JSON (JavaScript Object Notation) file, and the extraction algorithm 144 may be a JSON extraction algorithm. The JSON extraction algorithm extracts one or more eSIM status indicators 122. Upon extracting the one or more eSIM status indicators 122, processor 134 determines if the one or more eSIM status indicators 122 includes the newly activated eSIM indicator 122a.

### Select Smart Contract

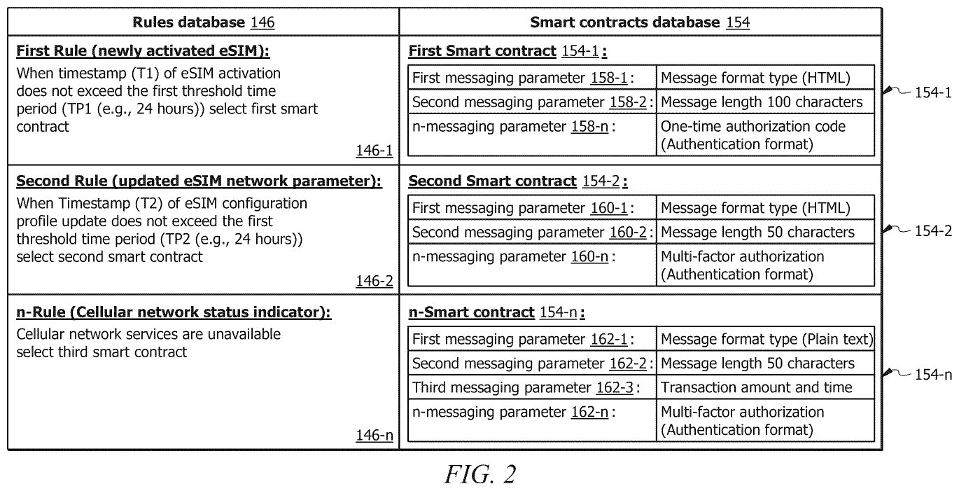

When processor 134 determines that one or more eSIM status indicators 122 includes the newly activated eSIM indicator 122a, then processor 134 accesses rules database 146 and determines if the first rule 146-1 associated with the newly activated eSIM indicator 122a is satisfied. The rules database 146 includes a plurality of rules 146-1 to 146-n. When a first rule 146-1 is satisfied, then processor 134 selects the first smart contract 154-1. With reference to FIG. 2, when a second rule 146-2 is satisfied, then processor 134 selects the second smart contract 154-2. When an n-rule 146-n is satisfied, then processor 134 selects the n-smart contract 154-n.

First rule 146-1 includes a condition for newly activated eSIM indicator 122a that when timestamp (T1) does not exceed the threshold time period (TP1), then select first smart contract 154-1. When eSIM 101 has been installed (i.e., activated) as a new eSIM 101 on user device 110-1, then cellular carrier networks 118-1 to 118-n may temporarily block cellular SMS (short message service) services on user device 110-1 for the threshold time period (TP1). This temporary blocking of cellular SMS services is performed as a precaution to avert any eSIM-related fraudulent attacks. For example, the threshold time period (TP1) is 24 hours. However, the threshold time period (TP1) may include 15 minutes, 1 hour, 2 days, or 1 month, or any other time period may be included as a threshold time period (TP1).

Processor 134 determines if a time period of 24 hours (TP1) has elapsed since the timestamp (T1) when eSIM 101 was installed (activated). Specifically, processor 134 determines if the threshold time period (TP1) of 24 hours has not been exceeded since the timestamp (T1), e.g., “Date: 2024-12-18, Time 15:45:00”. In response to determining that the threshold time period (TP1) of 24 hours (i.e., Date of 2024-12-19 and Time of 15:45:00) has not been exceeded, processor 134 selects the first smart contract 154-1 from the plurality of smart contracts 154-1 to 154-n. The first smart contract 154-1 includes messaging parameters 158-1 to 158-n. The messaging parameters 158-1 to 158-n are utilized by processor 134 to configure a first messaging request 130.

In an embodiment, the first messaging parameter 158-1 may include a message format type of HTML format or plain text format, although any other format may also be included. Second messaging parameter 158-2 may include a message length of 100 characters, 500 characters, or 50 characters, although any length of characters may also be included. N-messaging parameter 158-n may include an authentication format of a one-time authorization code or multifactor authorization, although any other type of authentication format may also be included. In an embodiment, a multifactor authorization may include transmitting a one-time authorization code to user device 110-1, and additionally, user device 110-1 may display a prompt asking previously configured security questions for authentication.

### Create the First Messaging Request and Initiate the Encrypted Alternate Messaging Platform

Processor 134 creates a first messaging request 130 based on the messaging parameters 158-1 to 158-n. With reference to FIG. 2, the messaging parameters 158-1 to 158-n include a first messaging parameter 158-1 (i.e., a message format type is HTML format), a second messaging parameter 158-2 (i.e., message length is 100 characters), and n-messaging parameter 158-n (i.e., authentication format is one-time authorization code e.g. “123456”). Upon creating the first messaging request 130 based on the messaging parameters 158-1 to 158-n, processor 134 encrypts the first messaging request 130.

The processor 134 encrypts the first messaging request 130 by utilizing a private-public key pair. The processor 134 utilizes an encryption algorithm (e.g., RSA (Rivest-Shamir-Adleman) or Elliptic curve cryptography) stored in the memory 128 to encrypt the first messaging request 130 using a public key. Upon encrypting the first messaging request 130, processor 134 initiates an encrypted alternate messaging platform 104-1 on the user device 110-1 to receive the encrypted first messaging request 130. The processor 134 transmits the first messaging request 130 to the encrypted alternate messaging platform 104-1, which is configured to display the first messaging request 130. The encrypted alternate messaging platform 104-1 applies a decryption algorithm that stores a private key to decrypt the first messaging request 130 and to extract the n-messaging parameter 158-n that includes the one-time authorization code “123456”. The one-time authorization code “123456” is interchangeably referred to as the first authentication data 130a. The encrypted alternate messaging platform 104-1 is configured to display the first messaging request 130. Thus, an end-to-end encrypted alternate messaging platform 104-1 is provided for transmission of the first messaging request 130, including the first authentication data 130a. One-time authorization code “123456” is utilized to authenticate the authentication request 120, explained in detail below.

In an embodiment, the encrypted alternate messaging platform 104-1 may be integrated within the application 106-1. In a certain embodiment, the encrypted alternate messaging platform 104-1 may be a standalone application installed on user device 110-1. Further, in conjunction with creating the first messaging request 130, processor 134 initiates the encrypted alternate messaging platform 104-1 on the user device 110-1.

Processor 134 receives a second authentication data from the user device 110-1 in response to transmitting the first messaging request 130. The second authentication data 138 may be an input received on user device 110-1 from user 102. For example, upon displaying the first messaging request 130 on the encrypted alternate messaging platform 104-1, the application 106-1 may display a prompt on user device 110-1 that would state, “Please enter the one-time authorization code”. User 102 enters the received one-time authorization code “123456” as a response to the prompt. This response from user device 110-1 is then transmitted to server device 114 as second authentication data 138.

In an embodiment, upon displaying the first messaging request 130 on the encrypted alternate messaging platform 104-1, the processor 134 executes instructions to cause the encrypted alternate messaging platform 104-1 to display a prompt on the encrypted alternate messaging platform 104-1 that would state, “Please enter the one-time authorization code”. User 102 enters the received one-time authorization code “123456” as a response to the prompt within the encrypted alternate messaging platform 104-1. This response from user device 110-1 is then transmitted to server device 114 as second authentication data 138.

### Compare the Received Second Authentication Data With the First Authentication Data

Processor 134 receives the second authentication data 138 and verifies if the code received in the second authentication data 138 matches the code included in the first authentication data 130a transmitted in the first messaging request 130. In response to determining that the code within the second authentication data 138 matches the authorization code of the first authentication data 130a, authentication request 120 is successfully authenticated. Upon successfully authenticating the authentication request 120, the data value is transferred from the first account to the other account to complete the wireless interaction. Thus, in response to authenticating the authentication request 120, the wireless interaction initiated on the user device 110-1 to transfer a data value from the first account to the other account stored in the user profile database 148 is completed.

Further, if it is determined that the code within the second authentication data 138 does not match the authorization code of the first authentication data 130a, authentication request 120 is denied.

In an embodiment, processor 134 is configured to determine if a successful delivery status notification is received from the user device 110-1 in response to transmitting the first messaging request 130 to the user device 110-1. The successful delivery status notification provides an indication of whether the first messaging request 130 was successfully delivered to user device 110-1. When processor 134 does not receive the successful delivery status notification from user device 110-1, then processor 134 determines that the first messaging request 130 was not successfully delivered to the user device 110-1.

Processor 134 then identifies the geographically closest one of the plurality of messaging service providers 136-1 to 136-n in response to determining that the first messaging request 130 was not successfully delivered to the user device 110-1. For example, processor 134 identifies messaging service provider 136-1 as geographically closest to the server device 114 compared to the plurality of messaging service providers 136-2 to 136-n. Processor 134 then transmits the authentication request 120 to the messaging service provider 136-1. Messaging service providers 136-1 to 136-n may include entities or organizations that are individually capable of authenticating the authentication request 120. Processor 134 then transmits a query request to the messaging service provider 136-1 to determine if the authentication of the authentication request 120 was completed in response to transmitting the authentication request 120 to the messaging service provider 136-1. Processor 134 receives a successful authentication status message from the first messaging service provider 136-1 in response to transmitting the query request to the first messaging service provider 136-1. In response to receiving the successful authentication status message from the messaging service provider 136-1, processor 134 determines that the authentication request 120 is successfully authenticated, and thus, processor 134 allows a data value to be transferred from the first account to the other account to complete the wireless interaction.

In an embodiment, when processor 134 receives an incomplete authentication status message from the messaging service provider 136-1 in response to transmitting the query request to the messaging service provider 136-1. Then, processor 134, for example, transmits the authentication request 120 to a messaging service provider 136-n. The messaging service provider 136-n is identified as the second geographically closest one of the plurality of messaging service providers 136-1 to 136-n after messaging service provider 136-1. The messaging service provider 136-n then performs authentication of the authentication request 120.

In an embodiment, when processor 134 determines that one or more eSIM status indicators 122 includes an updated eSIM network parameter, then processor 134 accesses rules database 146 and determines if the second rule 146-2 (FIG. 2) associated with the updated eSIM network parameter is satisfied. When second rule 146-2 is satisfied, then processor 134 selects the second smart contract 154-2. Second rule 146-2 has a condition that when timestamp (T2) does not exceed the threshold time period (TP2) then select second smart contract 154-2. During this threshold time period (TP2) cellular carrier networks 118-1 to 118-n may temporarily block cellular SMS (short message service) services on user device 110-1 when eSIM 101 is a new eSIM that has been installed (i.e., activated) on user device 110-1. For example, the threshold time period (TP2) is 24 hours. However, the threshold time period (TP2) may include 15 minutes, 1 hour, 2 days, or 1 month, any amount of time period may be included as a threshold time period (TP2). Processor 134 determines if a time period of 24 hours (TP2) has elapsed since the timestamp (T2). Specifically, processor 134 determines if threshold time period (TP2) of 24 hours has not been exceeded since the timestamp (T2) e.g., “Date: 2024-12-18, Time 15:45:00”. In response to determining that the threshold time period (TP2) of 24 hours has not been exceeded, processor 134 selects the second smart contract 154-2 from the smart contracts database 154. The second smart contract 154-2 includes messaging parameters 160-1 to 160-n. The messaging parameters 160-1 to 160-n are utilized by processor 134 (similar to messaging parameters 158-1 to 158-n) to configure the first messaging request 130. Next, the authentication of the authentication request 120 based on transmitting the first messaging request 130 to user device 110-1 is performed, as explained above.

In an embodiment, when processor 134 determines one or more eSIM status indicators 122 includes the cellular network status indicator (i.e., cellular network services are unavailable for the cellular carrier networks 118-1 to 118-n), then processor 134 accesses rules database 146 and determines that the n-rule 146-n is satisfied and processor 134 selects the n-smart contract 154-n. The n-smart contract 154-n includes messaging parameters 162-1 to 162-n. The messaging parameters 162-1 to 162-n are utilized by processor 134 (similar to messaging parameters 158-1 to 158-n) to configure the first messaging request 130. Next, the authentication of the authentication request 120 based on transmitting the first messaging request 130 to user device 110-1 is performed, as explained above.

### Quarantine Sector

In an embodiment, the authentication request 120 received from the user device 110-1 may include malicious software codes (i.e., a malicious file). The server device 114 may quarantine the authentication request 120 in a quarantine sector 150 within the memory 128 of the server device 114. A quarantine sector 150 is a memory sector created by the server device 114 such that any request (including the authentication request 120) stored in this quarantine sector 150 is not permitted or prevented from acting on files outside the quarantine sector 150. Thus, any malicious file included in the authentication request 120 is isolated in the quarantine sector 150 and thus cannot harm or attack the rest of the components outside the quarantine sector 150. Once the authentication request 120 is transferred into the quarantine sector 150, the server device 114 determines if the authentication request 120 includes a malicious file based on performing a scan of the authentication request 120. As part of the scan, the server device 114 accesses a database (stored within the quarantine sector 150) that includes known malicious software codes and determines if a software code (e.g., JSON (JavaScript Object Notation) code) of the received authentication request 120 (e.g., a JSON file format) includes the known malicious software codes. Server device 114 identifies the known malicious software codes based on previously determined malicious operations performed by the known malicious software codes. If at least a part of the software code of the authentication request 120 matches with any of the known malicious software codes, then the server device 114 mitigates any identified threat by deleting the malicious software code from the authentication request 120 to generate a sanitized version of the authentication request 120.

The sanitized version of the authentication request 120 is then analyzed by the processor 134 of the server device 114 to determine if the authentication request 120 includes one or more eSIM status indicators 122 (as explained above). In this manner, malicious attacks are mitigated by physically isolating the authentication request 120 onto the quarantine sector 150 and deleting the malicious software code from the authentication request 120 to create a sanitized version of the authentication request 120. Thus, by mitigating malware attacks before an attack takes place, the security of the server device 114 and information stored in the server device 114 is not compromised. Accordingly, the disclosed system provides a practical application and technical improvement for detecting malware threats and addresses and mitigating the malware threats before the malicious software code has a chance to infect the system.

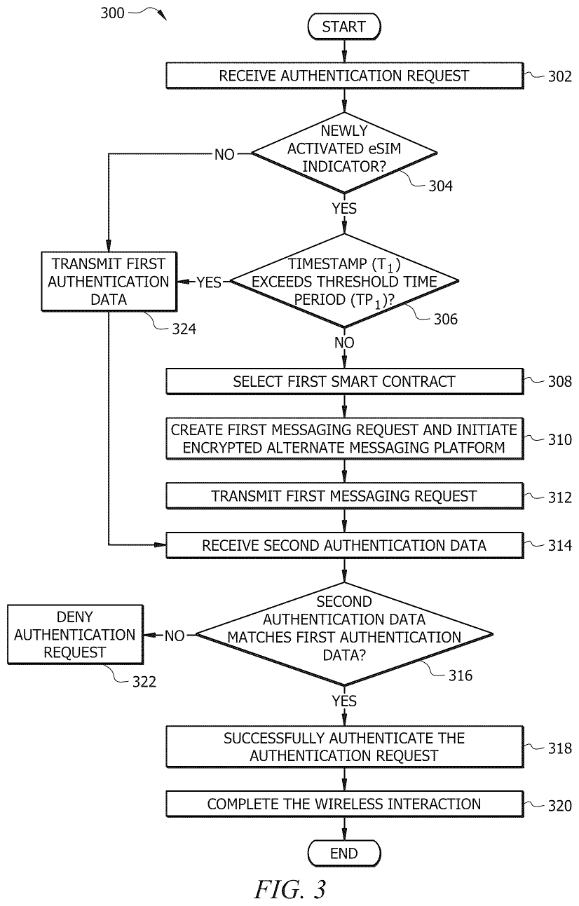

FIG. 3 illustrates an example flowchart of method 300 for generating an end-to-end encrypted alternate messaging platform to mitigate eSIM-related fraudulent attacks, in accordance with an embodiment of the present disclosure. For example, one or more operations of method 300 may be implemented, at least in part, in the form of software instructions 140 of FIG. 1, stored on a tangible non-transitory machine-readable medium or a computer-readable medium (e.g., memory 128 of FIG. 1) that, when run by one or more processors (e.g., processor 134 of FIG. 1) may cause the one or more processors to perform operations of the method 300.

Referring to FIG. 3, at operation 302, processor 134 of the server device 114 is configured to receive an authentication request 120 from the user device 110-1. The authentication request 120 includes one or more eSIM status indicators 122 associated with eSIM 101 of the user device 110-1.

At operation 304, processor 134 of the server device 114 determines if one or more eSIM status indicators 122 includes a newly activated eSIM indicator 122a. When processor 134 determines that the one or more eSIM status indicators 122 includes a newly activated eSIM indicator 122a, then the method takes the Yes branch and proceeds to operation 306.

At operation 306, processor 134 determines the timestamp (T1) indicating the time at which the eSIM 101 was activated that is included in the newly activated eSIM indicator 122a exceeds a threshold time period (TP1). When processor 134 determines if a time period (TP1) of, for example, 24 hours, has not been exceeded since the timestamp (T1), then the method takes the No branch and proceeds to operation 308.

At operation 308, processor 134 selects the first smart contract 154-1 from the smart contracts database 154.

At operation 310, processor 134 creates a first messaging request 130 based on the messaging parameters 158-1 to 158-n. Simultaneously, processor 134 initiates an encrypted alternate messaging platform 104-1 on the user device 110-1 to receive the encrypted first messaging request 130.

At operation 312, processor 134 transmits the first messaging request 130 (including the first authentication data 130a) to the encrypted alternate messaging platform 104-1, which is configured to display the first messaging request 130.

At operation 314, processor 134 receives a second authentication data from the user device 110-1 in response to transmitting the first messaging request 130.

At operation 316, processor 134 receives the second authentication data 138 and verifies if the code received in the second authentication data 138 matches the code included in the first authentication data 130a transmitted in the first messaging request 130. When the code received in the second authentication data 138 matches the code included in the first authentication data 130a, then the method proceeds to operation 318.

At operation 318, processor 134 determines that the code within the second authentication data 138 matches the authorization code of the first authentication data 130a, and thus authentication request 120 is successfully authenticated.

At operation 330, processor 134 upon successfully authenticating the authentication request 120, the data value is transferred from the first account to the other account to complete the wireless interaction.

Back at operation 316, when the code received in the second authentication data 138 does not match the code included in the first authentication data 130a, then the method proceeds to operation 322.

At operation 322, processor 134 denies the authentication request 120 is denied, and a notification to deny the wireless interaction is transmitted to user device 110-1.

Back at operation 306, when processor 134 determines if a time period (TP1) of, for example, 24 hours, has been exceeded since the timestamp (T1), then the method takes the Yes branch and proceeds to operation 324.

Back at operation 304, when processor 134 determines that the one or more eSIM status indicators 122 does not include a newly activated eSIM indicator 122a, then the method takes the No branch and proceeds to operation 324.

At operation 324, processor 134 transmits a first authentication data 130a to the user device 110-1 and the method then proceeds to operation 314, as explained above.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store a plurality of smart contracts, wherein a first smart contract of the plurality of smart contracts includes one or more messaging parameters utilized to configure a first messaging request displayed at an encrypted alternate messaging platform of a user device; and
a processor operably coupled to the memory and configured to:
receive, from the user device, an authentication request to authenticate a wireless interaction initiated at the user device, wherein the authentication request comprises one or more eSIM (embedded Subscriber Identity Module) status indicators associated with an eSIM of the user device and wherein the one or more eSIM status indicators comprises a newly activated eSIM indicator;
determine if the one or more eSIM status indicators comprises the newly activated eSIM indicator, wherein the newly activated eSIM indicator provides a timestamp indicating when the eSIM was activated in conjunction with the user device;
in response to determining that the one or more eSIM status indicators comprises the newly activated eSIM indicator, compare the timestamp with a threshold time period to determine if the timestamp exceeds the threshold time period;
in response to determining that the timestamp does not exceed the threshold time period, select the first smart contract of the plurality of smart contracts, wherein the first smart contract includes the one or more messaging parameters utilized to configure the first messaging request;
create the first messaging request based on the one or more messaging parameters;
in conjunction with creating the first messaging request, initiate the encrypted alternate messaging platform on the user device, wherein the encrypted alternate messaging platform is configured to display the first messaging request;
transmit the first messaging request to the user device, wherein the first messaging request includes a first authentication data utilized to authenticate the authentication request;
receive a second authentication data from the user device in response to transmitting the first messaging request;
compare the received second authentication data with the first authentication data to determine if the second authentication data matches with the first authentication data;
authenticate the authentication request of the user device based on determining that the second authentication data matches with the first authentication data; and
in response to authenticating the authentication request, complete the wireless interaction initiated at the user device.

2. The system of claim 1, wherein the processor is further configured to:
in response to transmitting the first messaging request to the user device, determine if a successful delivery status notification is received from the user device;
in response to determining that the successful delivery status notification is not received, determine that the first messaging request was not successfully delivered to the user device;
in response to determining that the first messaging request was not successfully delivered to the user device, transmit the authentication request to a first messaging service provider of a plurality of messaging service providers;
in response to transmitting the authentication request to the first messaging service provider, transmit a query request to the first messaging service provider to determine if the authentication request was completed;
in response to transmitting the query request to the first messaging service provider, receive an incomplete authentication status message from the first messaging service provider; and
in response to receiving the incomplete authentication status message from the first messaging service provider, transmit the authentication request to a second messaging service provider of the plurality of messaging service providers.

3. The system of claim 1, wherein the one or more messaging parameters comprises one or more authentication formats, and wherein the one or more authentication formats is a one-time authorization code format or a multifactor authentication format.

4. The system of claim 1, wherein the one or more messaging parameters comprises one or more message format types, and wherein the one or more message format types comprises an HTML message format type or a plain text message format type.

5. The system of claim 1, wherein the authentication request comprises a cellular network availability status, wherein the cellular network availability status indicates if a first cellular carrier network associated with the user device is unavailable.

6. The system of claim 5, wherein the processor is further configured to:
determine if the authentication request comprises the cellular network availability status;
in response to determining that the authentication request comprises the cellular network availability status, determine the first cellular carrier network associated with the user device is unavailable;
in response to determining that the first cellular carrier network is unavailable, select a second smart contract of the plurality of smart contracts, wherein the second smart contract includes another one or more of messaging parameters utilized to configure a second messaging request;
create a second messaging request based on the another one or more of messaging parameters;
in conjunction with creating the second messaging request, initiate the encrypted alternate messaging platform on the user device, wherein the encrypted alternate messaging platform is configured to display the second messaging request;
transmit the second messaging request to the user device, wherein the second messaging request includes a third authentication data utilized to authenticate the authentication request;
authenticate the authentication request of the user device based on the third authentication data; and
in response to authenticating the authentication request, complete the wireless interaction initiated at the user device.

7. The system of claim 6, wherein the processor is further configured to:
in response to transmitting a query request to a first messaging service provider, receive a completed authentication status message from the first messaging service provider; and
in response to receiving the completed authentication status message from the first messaging service provider, complete the wireless interaction initiated at the user device.

8. A method comprising:
receiving, from a user device, an authentication request to authenticate a wireless interaction initiated at the user device, wherein the authentication request comprises one or more eSIM (embedded Subscriber Identity Module) status indicators associated with an eSIM of the user device and wherein the one or more eSIM status indicators comprises a newly activated eSIM indicator;
determining if the one or more eSIM status indicators comprises the newly activated eSIM indicator, wherein the newly activated eSIM indicator provides a timestamp indicating when the eSIM was activated in conjunction with the user device;
in response to determining that the one or more eSIM status indicators comprises the newly activated eSIM indicator, comparing the timestamp with a threshold time period to determine if the timestamp exceeds the threshold time period;
in response to determining that the timestamp does not exceed the threshold time period, selecting a first smart contract of a plurality of smart contracts, wherein the first smart contract includes one or more messaging parameters utilized to configure a first messaging request;
creating the first messaging request based on the one or more messaging parameters;
in conjunction with creating the first messaging request, initiating an encrypted alternate messaging platform on the user device, wherein the encrypted alternate messaging platform is configured to display the first messaging request;
transmitting the first messaging request to the user device, wherein the first messaging request includes a first authentication data utilized to authenticate the authentication request;
receiving a second authentication data from the user device in response to transmitting the first messaging request;
comparing the received second authentication data with the first authentication data to determine if the second authentication data matches with the first authentication data;
authenticating the authentication request of the user device based on determining that the second authentication data matches with the first authentication data; and
in response to authenticating the authentication request, completing the wireless interaction initiated at the user device.

9. The method of claim 8, further comprising:
in response to transmitting the first messaging request to the user device, determining if a successful delivery status notification is received from the user device;
in response to determining that the successful delivery status notification is not received, determining that the first messaging request was not successfully delivered to the user device;
in response to determining that the first messaging request was not successfully delivered to the user device, transmitting the authentication request to a first messaging service provider of a plurality of messaging service providers;
in response to transmitting the authentication request to the first messaging service provider, transmitting a query request to the first messaging service provider to determine if the authentication request was completed;
in response to transmitting the query request to the first messaging service provider, receiving an incomplete authentication status message from the first messaging service provider; and
in response to receiving the incomplete authentication status message from the first messaging service provider, transmitting the authentication request to a second messaging service provider of the plurality of messaging service providers.

10. The method of claim 8, wherein the one or more messaging parameters comprises one or more authentication formats, and wherein the one or more authentication formats is a one-time authorization code format or a multifactor authentication format.

11. The method of claim 8, wherein the one or more messaging parameters comprises one or more message format types, and wherein the one or more message format types comprises an HTML message format type or a plain text message format type.

12. The method of claim 8, wherein the authentication request comprises a cellular network availability status, wherein the cellular network availability status indicates if a first cellular carrier network associated with the user device is unavailable.

13. The method of claim 12, further comprising:
determining if the authentication request comprises the cellular network availability status;
in response to determining that the authentication request comprises the cellular network availability status, determining if the first cellular carrier network associated with the user device is unavailable;
in response to determining that the first cellular carrier network is unavailable, selecting a second smart contract of the plurality of smart contracts, wherein the second smart contract includes another one or more of messaging parameters utilized to configure a second messaging request;
creating a second messaging request based on the another one or more of messaging parameters;
in conjunction with creating the second messaging request, initiating the encrypted alternate messaging platform on the user device, wherein the encrypted alternate messaging platform is configured to display the second messaging request;
transmitting the second messaging request to the user device, wherein the second messaging request includes a third authentication data utilized to authenticate the authentication request;
authenticating the authentication request of the user device based on the third authentication data; and
in response to authenticating the authentication request, completing the wireless interaction initiated at the user device.

14. The method of claim 13, further comprising:
in response to transmitting a query request to a first messaging service provider, receiving a completed authentication status message from the first messaging service provider; and
in response to receiving the completed authentication status message from the first messaging service provider, completing the wireless interaction initiated at the user device.

15. A non-transitory computer-readable medium storing instructions that, when executed by a processor, cause the processor to:
receive, from a user device, an authentication request to authenticate a wireless interaction initiated at the user device, wherein the authentication request comprises one or more eSIM (embedded Subscriber Identity Module) status indicators associated with an eSIM of the user device and wherein the one or more eSIM status indicators comprises a newly activated eSIM indicator;
determine if the one or more eSIM status indicators comprises the newly activated eSIM indicator, wherein the newly activated eSIM indicator provides a timestamp indicating when the eSIM was activated in conjunction with the user device;
in response to determining that the one or more eSIM status indicators comprises the newly activated eSIM indicator, compare the timestamp with a threshold time period to determine if the timestamp exceeds the threshold time period;
in response to determining that the timestamp does not exceed the threshold time period, select a first smart contract of a plurality of smart contracts, wherein the first smart contract includes one or more messaging parameters utilized to configure a first messaging request;
create the first messaging request based on the one or more messaging parameters;
in conjunction with creating the first messaging request, initiate an encrypted alternate messaging platform on the user device, wherein the encrypted alternate messaging platform is configured to display the first messaging request;
transmit the first messaging request to the user device, wherein the first messaging request includes a first authentication data utilized to authenticate the authentication request;
receive a second authentication data from the user device in response to transmitting the first messaging request;
compare the received second authentication data with the first authentication data to determine if the second authentication data matches with the first authentication data;
authenticate the authentication request of the user device based on determining that the second authentication data matches with the first authentication data; and
in response to authenticating the authentication request, complete the wireless interaction initiated at the user device.

16. The non-transitory computer-readable medium of claim 15, wherein the instructions further cause the processor to:
in response to transmitting the first messaging request to the user device, determine if a successful delivery status notification is received from the user device;
in response to determining that the successful delivery status notification is not received, determine that the first messaging request was not successfully delivered to the user device;
in response to determining that the first messaging request was not successfully delivered to the user device, transmit the authentication request to a first messaging service provider of a plurality of messaging service providers;
in response to transmitting the authentication request to the first messaging service provider, transmit a query request to the first messaging service provider to determine if the authentication request was completed;
in response to transmitting the query request to the first messaging service provider, receive an incomplete authentication status message from the first messaging service provider; and
in response to receiving the incomplete authentication status message from the first messaging service provider, transmit the authentication request to a second messaging service provider of the plurality of messaging service providers.

17. The non-transitory computer-readable medium of claim 15, wherein the one or more messaging parameters comprises one or more authentication formats, and wherein the one or more authentication formats is a one-time authorization code format or a multifactor authentication format.

18. The non-transitory computer-readable medium of claim 15, wherein the one or more messaging parameters comprises one or more message format types, and wherein the one or more message format types comprises an HTML message format type or a plain text message format type.

19. The non-transitory computer-readable medium of claim 15, wherein the authentication request comprises a cellular network availability status, wherein the cellular network availability status indicates if a first cellular carrier network associated with the user device is unavailable.

20. The non-transitory computer-readable medium of claim 19, wherein the instructions further cause the processor to:
determine if the authentication request comprises the cellular network availability status;
in response to determining that the authentication request comprises the cellular network availability status, determine if the first cellular carrier network associated with the user device is unavailable;
in response to determining that the first cellular carrier network is unavailable, select a second smart contract of the plurality of smart contracts, wherein the second smart contract includes another one or more of messaging parameters utilized to configure a second messaging request;
create a second messaging request based on the another one or more of messaging parameters;
in conjunction with creating the second messaging request, initiate the encrypted alternate messaging platform on the user device, wherein the encrypted alternate messaging platform is configured to display the second messaging request;
transmit the second messaging request to the user device, wherein the second messaging request includes a third authentication data utilized to authenticate the authentication request;
authenticate the authentication request of the user device based on the third authentication data; and
in response to authenticating the authentication request, complete the wireless interaction initiated at the user device.
